(19) United States
(12) Patent Application Publication
(10) Pub. No.: US 2005/0229925 A1
(43) Pub. Date: Oct. 20, 2005

(54) Method for the treatment of starch

(76) Inventor: Hannu Ketola, Hameenlinna (FI)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/514,779

(22) PCT Filed: May 20, 2003
(86) PCT No.: PCT/FI03/00388

§ 371 Date: Nov. 17, 2004

(30) Foreign Application Priority Data
May 20, 2002 (FI) 20020942

(51) Int. Cl. C08B 30/00; C08B 33/08

(52) U.S. Cl. 127/71; 536/105

(57) ABSTRACT

A method for the modification of a starch or a starch derivative for decreasing the viscosity of the same in the presence of hydrogen peroxide, a metal catalyst, especially copper sulphate and optionally an agent for increasing the pH so that the dry matter content at the beginning of the modification is at least 60%. The invention also involves use of the modified starch in i.a. surface sizing of paper.

This invention relates to a method for the preparation of a low viscosity starch.

Starch is the most common additive for increasing the dry strength of paper. Starch is used for increasing the dry strength of paper on the paper machine in two ways: by adding the starch to the wet part of the paper machine into the stock (stock starch) or by applying a starch solution to the surface of the dried paper (surface size starch). A third application utilizing the dry strength property of the starch is as a binder in a coating colour, wherein starch is used together with a synthetic latex to bind the coating pigments to the paper.

In order for the starch to be usable in the above mentioned applications, it has to be modified in a suitable manner. Conventional modifications include e.g. cationization of starch and chain degradation.

Starch to be added to the stock is normally modified in cationic form by substituting therein a cationic ammonium group, thus facilitating the bonding of the starch to the anionic fibres. The level of addition of stock starch is normally 0.5 to 1.5% of the weight of the paper.

In its application as a surface size, more starch is added to the paper, normally 3 to 5% of the weight of the paper. Due to the higher addition rate, the starch solution has also to be more concentrated; often an appr. 8 to 15% dry matter content is required of a surface size solution depending on the apparatus and the trend is in the direction of even higher dry matter contents. The maximum dry matter content of a solution made from unmodified raw starch, at which it can still be pumped and dosed with the application apparatus, is however only appr. 5%. For this reason, the starch has to be modified to a lower viscosity for these applications, that is the starch has to be thinned, in order for it to be pumped and dosed also at a higher dry matter concentration.

The viscosity decrease is carried out by degrading the starch chains into shorter fragments for example by oxidation or hydrolyzing with an acid. A corresponding modification has also to be carried out on starch to be used as a binder in a coating colour, because in coating colour manufacture one aims at a dry matter content which is as high as possible. In both cases, a high dry matter content is advantageous from the point of view of drying costs of the paper, when the paper is dried again after the surface sizing or coating.

The modification of starch, for example cationization or chain degradation, for the above mentioned applications is usually done in slurry form, that is the starch has been slurried into water and this slurry has been treated for example with pH adjustment chemicals and reagents. Usually the modification also requires raising the slurry temperature. The temperature of the starch slurry cannot, however, be increased over the dissolution temperature (gelatinization temperature) of the starch, as the starch has to be dried after the modification back to a powder, which is not successful if the grains are damaged. When drying a slurry modified product, about half of the slurry water is removed by filtering, whereby effluents are produced.

In order to prevent the formation of effluents, one has started to develop so called dry modification methods, in which the chemicals are added to the dry starch.

Dry cationization is already in use in commercial production and there are also patent publications relating to the method, for example U.S. Pat. No. 4,127,563 and DE 3604796.

Also dry modifications which degrade starch chains have been patented. Dry oxidation with hydrogen peroxide, which is as such known as a slurry method (R. W. Kerr, Chemistry and Industry of Starch, Academic Press Inc., 1950, p. 313 and 326) is disclosed in the publication WO 00/31145. According thereto, the viscosity of starch is lowered by treating the starch with hydrogen peroxide using as catalyst an acid or an acidic anhydride. In the method, the starch is heated at 80 to 140° C. for many hours. In practice the method is acid catalyzed since the anhydride is transformed to an acid under the influence of moisture.

Another method disclosed in the patent literature is the application, as a dry process, of a method involving thinning with an acid and also known as a slurry process, U.S. Pat. No. 5,766,366. In the method, a chemical which hydrolyzes the glucosidic bonds of the starch is used for degrading dry starch in a plug flow reactor at a temperature of 21 to 77° C. for period of 0.5 to 6 hours. The shortest reaction times are attainable by using hydrogen chloride gas, hydrochloric acid or sulfuric acid.

In both afore mentioned methods, the reaction is carried out under acidic conditions and the product has to be neutralized at the end of the treatment.

It is also possible to degrade starch in slurry form with hydrogen peroxide using a metal catalyst, e.g. U.S. Pat. No. 3,655,644, U.S. Pat. No. 3,975,206 and U.S. Pat. No. 2,276,984. Under alkaline or neutral conditions, the reaction times vary over a wide range (e.g. 8 to 12 hours), the shortest reaction time being 3 hours. Under acidic conditions the reaction time is 2 to 5 hours under optimum conditions.

In the method according to the present invention starch or a starch derivative is treated in order to modify, i.e. degrade the same with hydrogen peroxide in the presence of a metal catalyst. The method is characterized in that the dry matter content of the reaction mixture at the beginning of the modification reaction is at least appr. 60%, advantageously at least appr. 70%.

In the method according to the invention a reaction temperature of preferably 25 to 60° C., especially advantageously 40 to 60° C. is used. In the method according to the invention, the desired degradation degree of the starch is achieved already with a reaction time of 0.25 to 4 hours, often already in 0.25 to 2 hours. An advantage as compared to the corresponding slurry process (U.S. Pat. No. 36,556,648, U.S. Pat. No. 3,975,206) is, in addition to the shorter reaction times, that the formation of effluents is avoided. Compared to the above disclosed acid catalyzed treatment with hydrogen peroxide (WO 00/31145), an advantage is i.a. the use of a distinctly lower reaction temperature and shorter reaction time. Both afore mentioned facts are naturally advantageous from a manufacturing technical standpoint as they i.a. decrease production costs. In addition, with the method according to the invention the treatment can be carried out also in neutral and alkaline conditions. As a consequence hereof, the corrosion problems with the apparatus decrease which is a big advantage as compared to the acid catalyzed treatment or a treatment carried out solely by means of an acid.

Degradation of starch can be evaluated e.g. by cooking a starch solution of the modified starch and measuring the viscosity of the starch solution. The viscosity of the starches degraded with the method according to the invention is advantageously in the range of 15 to 300 mPas. The viscosity of such starches that have been degraded with the method according to the invention, which are especially suitable for the purposes of surface sizing and/or coating colour, is advantageously in the range of 40 mPas to 300 mPas, especially advantageously 50 to 200 mPas. The said viscosity values are Brookfield100 viscosity values as measured at a temperature of 80° C. and a dry matter content of 20%. By cooking is meant, in connection with the above mentioned viscosity values, cooking at 95° C. during 15 minutes.

The treatment according to the invention is preferably carried out under almost neutral, neutral or alkaline conditions. Hereby especially an agent for raising the pH to a neutral or alkaline pH range is added at the beginning of the modification so that the pH of a solution cooked from the end product is essentially in the neutral or alkaline range. The pH of the size cooked from the final product can also be in the acid range, e.g. pH 3 to 5. The pH at the beginning of the degradation modification is advantageously neutral or alkaline and can be at the end neutral, alkaline or acidic, depending on the reaction conditions. The pH at the beginning of the modification, as measured from the reaction mixture slurried in water, immediately after all the substances are added and intermixed, can be e.g. 7 to 10, advantageously 8 to 10.

Research has shown that the reaction rate is often surprisingly even higher in neutral or alkaline conditions as compared to acidic conditions, which makes the production more favourable especially when the starting product is a starch derivative made by cationizing, for example when preparing cationic surface sizes which require that the starch is both cationized and degraded to a lower viscosity. As the cationization is almost always carried out at a high pH, it is advantageous that the cationized product is not further treated in a process wherein acid is used as it would introduce excessive salt into the product. A lower salt content naturally leads to a purer end product. The method according to the invention is especially advantageous to use for reducing the viscosity of the starch immediately after cationization, for example in the same reactor. When dry cationization has been performed under alkaline conditions, the base catalyst used in the cationization can be utilized in the modification according to the invention i.e. the degradation of starch so that degradation is started in the alkaline range, advantageously close to the pH or substantially at the same pH as in the preceding cationization, especially at the end of the cationization. Hereby especially the modification according to the invention can be performed without adding an agent for raising the pH. However, the reaction mixture may include an agent for adjusting the pH from the cationization modification. The pH of the reaction mixture at the beginning of the modification of the viscosity of a dry cationized starch according to the invention is advantageously 8 to 10. The pH of a reaction mixture which has been dry cationized can sometimes be 10 to 11 after cationization. Especially in cases like this the pH of the dry cationized starch can also suitably be decreased with a weak acid, e.g. citric acid, for the purpose of the following modification, i.e. degradation of the starch, to the range of e.g. 8 to 10.

The method according to the invention can be used for reducing the viscosity of any suitable starch or starch derivative by degrading the starch chain. As starch one can use for example starch derived from cereals, such as e.g. corn, wheat, rice, oats, etc., or starch isolated e.g. from tuberous plants, such as e.g. potato or tapioca. The starch to be used can be a chemically modified starch derivative, which has been obtained for example by introducing anionic or cationic groups into the starch, with an etherification or esterification reaction, or with a combination of these treatments. The starch derivative can be modified in a dry or semi-dry state, or modified in slurry form and dried. It is especially advantageous to use dry cationized starch.

The starch or starch derivative to be used according to the invention is added in dry form, preferably at a dry matter content of appr. 80 to 90%. Especially advantageously the starch to be added to the reaction vessel is at the equilibrium dry matter content with the surrounding air. The equilibrium dry matter content of starch is normally above 80%. The equilibrium dry matter content of natural or modified starch varies between appr. 80% and 90% depending on the starch species (for example potato appr. 80%, cereal appr. 90%) under normal conditions (20° C., 65% relative humidity). The dry matter content of the starch or starch derivative to be added can also be higher, for example above 90%, often at the most appr. 95%.

Moisture or water is introduced into the reaction mixture also together with other substances besides the starch. Thus, at the beginning of the modification reaction, when the substances to be used in the modification have been added to the reaction vessel, the dry matter content of the reaction mixture is often appr. 70 to 85%, especially appr. 70 to 78%. Depending e.g. on the dry matter content of the starch or starch derivative to be added, which sometimes can be appr. 70 to 75%, the dry matter content of the reaction mixture at the beginning of the modification reaction can be even below appr. 70%. As the starch or starch derivative is dry modified in the method according to the present invention, the dry matter content of the reaction mixture is at least appr. 60%, especially at least appr. 70% at the beginning of the modification reaction.

As metal catalyst, a metal ion, such as for example iron, cobalt, chromium, advantageously copper is used in the form of a suitable salt, especially advantageously copper sulfate. The said metal ion must have the ability to exist at several oxidation numbers. In the method according to the invention use is made of the ability of the metal catalyst to change its oxidation number. It has been observed that when the oxidation number changes to a lower level, it oxidatively degrades starch chains. By means of the hydrogen peroxide the metal ion is restored to its original oxidation number. The reaction progresses until the peroxide is consumed or the reaction is terminated by using a reducing agent.

The amount of added metal catalyst can vary for example in the range of 0.001% to 0.2%, calculated as mass percentages from the amount of dry (oven dried; 105° C.) starch. The amount of metal catalyst is especially advantageously 0.010 to 0.15 mass % calculated from the starch dry matter. The said amount has been obtained experimentally by using copper sulfate. When using other catalysts it is to be observed that one uses an equivalent amount of the metal ion acting as the catalyst. The metal salt is advantageously added in the form of an aqueous solution, the salt content of which can be adjusted taking into account the amount of moisture introduced into the reaction mixture. A suitable concentration is for example a 1% aqueous solution of the metal salt, of which a suitable amount is added to the reaction mixture.

Without adjustment upwards, the pH of the reaction mixture at the beginning of the modification is often approximately in the neutral range (6 to 7), from which it decreases down to the range of 3 to 5, depending on the amount of the oxidizing agent. As the pH has a tendency to decrease during the oxidation reaction, advantageously an agent which increases the pH is used in the method according to the invention. For example the inorganic carbonates, hydroxides or oxides, such as calcium or sodium carbonate or sodium or calcium hydroxide, alone or in mixture, are suitable for use as such an agent. Especially advantageously sodium bicarbonate is used. By adding said agent, the pH of the reaction mixture is increased at the beginning of the modification. The pH of the reaction mixture decreases when the modification progresses. The pH of the end product thus depends i.a. on the amount of hydrogen peroxide used and the amount of reagent intended for raising the pH.

An agent for raising the pH may also be added even at any other time during the modification than at the beginning of the modification when the substances of the reaction mixture are intermixed. If the said addition is performed also at other times during the modification, a lower pH at the beginning of the modification can be chosen and the pH of the reaction mixture will alter less during the modification. However, it is advantageous that all of the agent for raising the pH is added at the beginning of the modification.

The pH of an aqueous solution of the cooked end product is so adjusted that at the beginning of the modification an amount of the agent intended for raising the pH is dosed, which first has been, for example experimentally, found to be suitable for obtaining the desired pH in the end product at the specific reaction conditions. After termination of the modification, either by interrupting the reaction with reducing agents or after complete consumption of the hydrogen peroxide, the pH of an aqueous solution cooked from the modified starch is preferably neutral or alkaline. The said pH value of the end product as measured from a cooked starch solution is e.g. 5 to 9.5, advantageously 5 to 8 and especially advantageously 6 to 7. The agent for raising the pH can be added to the reaction mixture in a suitable manner, for example in dry form.

When carrying out the modification without adding an agent for raising the pH, the pH value of the end product is in the acidic range, appr. 3 to 5, when measured from a cooked starch solution. Although the reaction proceeds slower in the acidic range, the necessary reaction time can still be short, for example approximately one hour, as in the test 1 of Example 1. In such a case the product has to be neutralized after modification in a separate step. The Example 2 illustrates the use of a starch modified according to the invention in the surface sizing of paper without the addition of an agent for raising the pH.

The amount of hydrogen peroxide, calculated as mass percentages from the dry matter of the starch, can vary depending on the desired degree of degradation and it can suitably be, for example, in the range 0.05% to 3%, suitably 0.1 to 2%. The amount of hydrogen peroxide is chosen in accordance with the desired viscosity level for the end product. A lower viscosity level is attained with a larger amount of H₂O₂. The hydrogen peroxide is added to the starch suitably as an aqueous solution, the H₂O₂ concentration of which can vary, but which for practical purposes is suitably for example in the range of 15% to 35%. The concentration can also be varied in accordance with the dosage. Naturally it is advantageous to add a smaller amount of hydrogen peroxide as a more dilute solution so that the amount of solution is sufficient to mix the hydrogen peroxide well into the starch. Liquid substances, such as aqueous solutions, are advantageously added to the reaction mixture by spraying maintaining the reaction mixture in motion in a reactor or reaction vessel which is suitable for the mixing of liquids and solid substances. Such can be for example a horizontal drum equipped with plough-like blades, which are attached to an axle extending through the drum, which axle is rotated with an electrical engine. For adjusting the temperature the reactor can be provided with a (heating) casing. According to one embodiment, the metal salt and the hydrogen peroxide can be added to the reaction mixture together in one and the same solution. When adding the metal salt and the hydrogen peroxide separately, the metal salt is advantageously added prior to the hydrogen peroxide.

The reaction can be performed at room temperature or at a temperature only slightly above room temperature, preferably at 25 to 60° C., especially advantageously at 40 to 60° C. The reaction can also be performed at a higher temperature, for example at 60 to 80° C., even at 100° C., as the gelatinization temperature of the starch does not present an upper limit to the reaction temperature in a dry process. The reaction temperature has an effect on the reaction rate. A reaction time during which almost all hydrogen peroxide has decomposed, is appr. 15 min to 4 hours, preferably at the most two hours, or even less than one hour. As is evident from the enclosed working examples, a sufficient degree of reaction has in some cases been achieved using reaction times of even 15 min. Especially neutral or alkaline conditions accelerate termination of the reaction. For example the capacity of the production line and energy consumption can affect the upper limit of the reaction temperature to be chosen in any specific case.

The course of the reaction can be monitored by taking a sample from the reaction mixture at suitable time intervals and determining the reacted or remaining hydrogen peroxide. The pH during the reaction can be monitored by slurrying a sample from the reaction mixture in water and determining the pH of the water suspension. If desired, the reaction can be interrupted by using a reducing agent, such as for example sodium metabisulfite or sodium thiosulfate, but it is advantageous to allow the reaction to proceed until all or almost all hydrogen peroxide has decomposed and to choose the amount of hydrogen peroxide already in the beginning to be one that gives the desired degradation degree when the added hydrogen peroxide has been consumed or almost consumed completely. The modified starch obtained after the reaction, especially such having a neutral pH is as such usable for the desired purpose. This is especially advantageous because the only means for removal of the salt used for neutralizing the product comprises washing the product and the product would have to be slurried in water although the modification otherwise is performed in the dry state.

The viscosity of the modified starch is determined by cooking a starch solution having a dry matter content which is suitable for the purpose and the viscosity of the starch solution is measured at the chosen temperature. For example a Brookfield viscosimeter is used for measuring the viscosity using the chosen rotational speed. When comparing the viscosities of different starch solutions, naturally the dry matter content of the cooked solution and measuring conditions have to be taken into account. The dry matter content of the starch solution to be cooked (oven dried; 105° C.) is often 20% or 10%. Cooking is usually carried out at 95° C. for a period of appr. 15 min. The viscosity is usually measured from the prepared solution, whereby the temperature of a solution cooked e.g. in the processing equipment is for example 80° C. or the temperature of e.g. a laboratory cooked solution is for example 60° C. A rotational speed of e.g. 100 revolutions/min is used in the Brookfield viscosimeter (Brookfield100 viscosity). The Brookfield100 viscosity of starches suitable for surface size or coating application is usually, measured at a temperature of 80° C. and a dry matter content of 20%, in the range of appr. 50 to 300 mPas. The corresponding Brookfield100-values as measured at 60° C. and at a concentration of 10% would be appr. 25 to 150 mPas.

The modification of starch with the method according to the invention for decreasing the viscosity of the starch is performed especially advantageously so that the pH of the starch solution cooked from the final product is in substantially the neutral range and its viscosity (Brookfield100, 80° C., dry matter content of 20%) is in the range of 15-300 mPas, depending on each application.

It is especially advantageous to use the method according to the invention for degrading e.g. cationic starch. As the cationization is carried out at a high pH, it is advantageous that the product is further treated in a process in which alkaline or neutral conditions can be used. In this case pH adjustment back and forth is reduced as a result of which the amount of salt remaining in the product and thus also any additional costs decrease when thinning cationic starch, the amount of raw material decreasing and because the end product need not be washed in order to purify the product from the salt, which would be especially difficult or impossible without slurrying the product in water, which would eliminate the above mentioned advantages achieved using dry modification

In the following some advantageous embodiments of the method according to the invention are described by means of working examples.

### EXAMPLE 1

In this example the substances used for degrading a starch, their amounts and reaction conditions are described.

The tests in the example have been carried out on potato starch, with a equilibrium dry matter content of 80 to 82% under ambient conditions. Hydrogen peroxide was used for the modification of the starch using copper sulfate (CuSO₄.H₂O) as the catalyst and agents for increasing the pH. The added amounts of the substances and the reaction temperature were varied.

The Table 1 discloses the substances used and amounts, the reaction temperature as well as measurement results from the progress of the reaction and from the size cooked from the end product. The amounts of the substances are indicated as mass percentages from the amount of starch (oven dry; 105° C.).

The hydrogen peroxide and the copper sulfate used as the catalyst were added as a 1% solution by spraying and the reagent used for increasing the pH as a solid powder. The reaction has been carried out in a heatable laboratory scale mixing reactor to which at a time 1000 g starch is added. The progress of the reaction was monitored by intermittently retrieving a sample and determining the amount of reacted hydrogen peroxide. Finally a 20% starch solution was prepared by cooking using tap water in the above mentioned manner and the pH and the viscosity of the solution were determined, the temperature of the solution being 80° C. The viscosity of the cooked solution was determined with a Brookfield RVT viscosimeter using a rotational speed of 100 rev/min.

In the tests 5, 6, 7 and 8 the pH of the reaction mixture was measured also immediately after mixing the other substances into the starch. The reaction mixture was slurried (dry matter content 20%) into tap water for measuring the pH. The pH-values of the said test samples of the said slurried reaction suspension were 10.0; 9.0; 8.9 and 7.5, respectively. As is seen from the results, the pH of the end product can be maintained at the desired value by changing the amount of agent used for raising the pH. The agent for raising the pH has an effect on the reaction rate in addition to the pH. Good results are obtained by using sodium bicarbonate. The reaction can be carried to completion in 15 minutes, when fastest The reaction temperature can be even 40° C., in which case the reaction goes to completion in 30 minutes. In the test no. 3, the copper sulfate and hydrogen peroxide solution were intermixed before addition. This test shows that also this kind of a technique can be used.

TABLE 1

| | | | | | | | Reaction | | | | | Cooked size | | |
|---|---|---|---|---|---|---|---|---|---|---|---|---|---|---|
| | | | | | | | tem- | | | | | | | Dry |
| Test | CuSO₄.5H₂O | H₂O₂ | CaCO₃ | Ca(OH)₂ | Na₂CO₃ | NaHCO₃ | perature | Reaction progress - % reacted | | | | | Viscosity | matter |
| no. | % | % | % | % | % | % | ° C. | 15 min | 30 min | 45 min | 60 min | pH | mPas | % |
| 1 | 0.075 | 1.35 | | | | | 55 | 29 | 65 | 88 | 97 | 3.0 | 39 | 20 |
| 2 | 0.065 | 2.73 | 2.5 | | | | 50 | 51 | 88 | 99.5 | | 4.9 | 18 | 20 |
| 3*) | 0.076 | 1.38 | 1.0 | | | | 50 | 15 | | 74 | 95 | 5.0 | 45 | 20 |
| 4 | 0.110 | 2.40 | | 1.0 | | | 50 | 89 | 93 | | | 9.1 | 270 | 19 |
| 5 | 0.075 | 1.20 | | | 1.5 | | 50 | 98 | | | | 7.8 | 270 | 20 |
| 6 | 0.070 | 1.32 | | | 0.5 | | 50 | 66 | 98 | | | 5.1 | 126 | 20 |
| 7 | 0.088 | | | | 1.35 | 2.0 | 50 | 98 | | | | 8.1 | 70 | 20 |
| 8 | 0.084 | 1.44 | | | | 1.5 | 45 | 99 | | | | 5.3 | 65 | 18 |
| 9 | 0.035 | 1.32 | | | | 1.4 | 40 | 65 | 99 | | | 6.6 | 56 | 20 |
| 10 | 0.035 | 1.26 | | | | 1.2 | 40 | 54 | 99 | | | 6.0 | 68 | 20 |
| 11 | 0.080 | 1.44 | | | | 1.0 | 50 | 99 | | | | 4.5 | 62 | 20 |

*)Copper sulfate and peroxide added together

### EXAMPLE 2

This example discloses the applicability of a cationic surface size prepared on a pilot scale.

150 kg of cationic starch (substitution degree 0.015 and equilibrium dry matter content appr. 80 to 82%) was oxidized at 50° C. using 0.013 mass % of copper sulfate as catalyst and 1.3 mass % of hydrogen peroxide. The reaction time was 1 hour.

The prepared product (test product) was tested as a surface size on a test coating machine and was compared as to a number of properties mentioned in the table to a commercial product (reference) prepared as a slurry process by oxidizing with sodium hypochlorite. The viscosity of the cooked starch was measured as is disclosed in the example 1. The results are given in Table 2 from which it can be seen that by means of a product that has been thinned with the method according to the invention, one achieves corresponding surface strength, porosity, smoothness and optical properties of the surface sized paper as compared with a corresponding commercial product that has been manufactured in a slurry process.

TABLE 2

| | Dry | | | Dennison | Porosity | Smoothness | ISO | |
|---|---|---|---|---|---|---|---|---|
| | matter | Viscosity | Temperature | surface | Bendtsen | PPS | brightness | Opacity |
| | % | mPas | ° C. | strength | ml/min | μm | % | % |
| Test product | 9.1 | 38 | 45 | 16 | 567 | 6.1 | 88.8 | 90.2 |
| Test product | 6.9 | 24 | 47 | 14 | 660 | 7.5 | 89.0 | 90.3 |
| Reference | 9.1 | 29 | 42 | 16 | 592 | 6.9 | 89.2 | 90.1 |
| Reference | 7.1 | 20 | 44 | 14 | 658 | 7.4 | 89.2 | 90.7 |

1. Method for the modification of a starch or a starch derivative by treating said starch or starch derivative with hydrogen peroxide in the presence of a metal catalyst, characterized in that the dry matter content of the reaction mixture is at least 60% at the beginning of the modification reaction.

2. The method according to claim 1, characterized in that the starch or starch derivative is added to the reaction vessel at a dry matter content of at least 70%.

3. The method according to claim 1, characterized in that the metal catalyst is a metal ion having several oxidation numbers.

4. The method according to claim 3, characterized in that the metal catalyst is copper.

5. The method according to claim 4, characterized in that the amount of copper is 0.001 to 0.2 mass % calculated from the starch dry matter.

6. The method according to claim 1, characterized in that the amount of hydrogen peroxide is 0.05 to 3 mass % calculated from the starch dry matter.

7. The method according to claim 1, characterized in that the modification is carried out in the presence of an agent for raising the pH.

8. The method according to claim 7, characterized in that the agent for raising the pH is selected from the group consisting of an inorganic carbonate, an hydroxide and an oxide.

9. The method according to claim 8, characterized in that the inorganic carbonate is calcium or sodium carbonate and the hydroxide is calcium or sodium hydroxide.

10. The method according to claim 7, characterized in that the amount of agent for raising the pH is such that the pH of an aqueous solution made by cooking of the modified starch is 5 to 8.

11. The method according to claim 7, characterized in that the amount of agent for raising the pH is such that the pH at the beginning of the modification reaction is in the neutral or alkaline range.

12. The method according to claim 11, characterized in that the amount of agent for raising the pH is such that the pH at the beginning of the modification reaction is 7 to 10.

13. The method according to claim 1, characterized in that the reaction time is 0.25 to 4 hours.

14. The method according to claim 1, characterized in that the reaction temperature is 25 to 80° C.

15. The method according to claim 1, characterized in that the viscosity of the modified starch measured from the solution cooked thereof is in the range of 30 to 300 mPas (Brookfield100: dry matter content 20%, 80° C.).

16. The method according to claim 1, characterized in that the starch derivative is a cationic starch.

17. The method according to claim 16, characterized in that the starch derivative is modified after cationization in the same reaction vessel.

18. A method of surface sizing a paper by adding the starch or the starch derivative made by a method according to claim 1 to the surface of the dried paper or by adding to the wet part of a paper stock.

19. The method according to claim 1, characterized in that the starch or starch derivative is added to the reaction vessel at a dry matter content of at least 80 to 90%.

20. The method according to claim 4, characterized in that the metal catalyst is copper sulfate.

21. The method according to claim 5, characterized in that the amount of copper sulfate is 0.010 to 0.15 mass % calculated from the starch dry matter.

22. The method according to claim 6, characterized in that the amount of hydrogen peroxide is 0.1 to 2 mass % calculated from the starch dry matter.

23. A method of binding a coating color in paper manufacturing to paper by adding the starch or starch derivative made by a method according to claim 1 to the coating color and coating the paper.

24. A method according to claim 9, characterized in that the inorganic carbonate is sodium bicarbonate.

25. The method according to claim 16, characterized in that the starch derivative is a dry cationized starch.
